(19) United States
(12) Patent Application Publication
(10) Pub. No.: US 2010/0146707 A1
(43) Pub. Date: Jun. 17, 2010

(54) DEVICE AND METHOD FOR RELIEVING BACK PAIN

(76) Inventor: Orlando Calvo, Panama (PA)

Correspondence Address: STROOCK & STROOCK & LAVAN LLP, 180 MAIDEN LANE, NEW YORK, NY, 10038, US

(21) Appl. No.: 12/632,795

(22) Filed: Dec. 7, 2009

Related U.S. Application Data
(63) Continuation-in-part of application No. 11/707,308, filed on Feb. 16, 2007, now Pat. No. 7,644,460.

(30) Foreign Application Priority Data
Oct. 23, 2006 (PA) 087003

(51) Int. Cl. A61G 7/05

(52) U.S. Cl. 5/648

(57) ABSTRACT

The present invention relates to an apparatus for relieving back pain, the apparatus having a top and a leg assembly for supporting the top when the apparatus is placed on a surface. A method of relieving back pain is also provided, wherein a user adjusts the height of an apparatus according to the user's buttock popliteus length, and lay on the surface and place his/her lower legs or feet on the top of an apparatus such that the knees are bent at substantially 90 degrees and his/her back is flat on the surface.

### CROSS-REFERENCE TO RELATED APPLICATIONS

This patent application is a continuation-in-part of and claims priority under 35 U.S.C. §120 to U.S. patent app. Ser. No. 11/707,308, filed Feb. 16, 2007, entitled “DEVICE AND METHOD FOR RELIEVING BACK PAIN,” which claims priority under 35 U.S.C. §119 to Panama Patent App. No. 087003, dated Oct. 23, 2006, both of which are hereby incorporated herein by reference.

### FIELD OF INVENTION

The present invention relates to treatment of back ailments and, more particularly to a device and method for relieving back pain of persons of varying height.

### BACKGROUND OF THE INVENTION

It is well known that back pain is commonly experienced by people all around the world, and various methods of treatment are also well known, including different devices and mechanisms. However, these known devices typically have a fixed height, and the effectiveness of the methods and devices may vary by the height of the person.

Accordingly, it is desirable to provide a device for relieving back pain wherein the device is adjustable, and thus suitable for use by persons of different heights. It is also desirable to provide a method of relieving back pain for persons of different heights using an adjustable apparatus.

### SUMMARY OF THE INVENTION

A device for and a method of relieving back pain are provided. An exemplary embodiment of the invention provides a leg rest having an adjustable height for a user to support his/her legs while lying down on his/her back. The height can preferably be adjusted to permit the user's knees to be bent at a 90° angle.

Embodiments of the present invention also relate to a method of relieving back pain by elevating the feet while lying down, such that the user's thighs are at a 90° angle with respect to the user's back and calves, the calves and/or feet resting on a device having an adjustable height according to an embodiment of the present invention. In certain embodiments, the device is collapsible for storage.

Other objects and features of the present invention will become apparent from the following detailed description, considered in conjunction with the accompanying drawing figures. It is to be understood, however, that the drawings are designed solely for the purpose of illustration and not as a definition of the limits of the invention, for which reference should be made to the appended claims.

### BRIEF DESCRIPTION OF THE DRAWINGS

The particular features and advantages of the invention as well as other objects will become apparent from the following description taken in connection with the accompanying drawings, in which:

FIG. 1 is a side elevational view of a device in accordance with an embodiment of the invention;

FIG. 2 is a front elevational view of a device in accordance with an embodiment of the present invention;

FIG. 3 is a top planar view of a device in accordance with an embodiment of the present invention;

FIG. 4 is a bottom planar view of a top of a device in accordance with an embodiment of the invention;

FIG. 5 is a side elevational view of a device being used in accordance with an embodiment of the present invention;

FIG. 6 is a side view of a device in accordance with an embodiment of the present invention showing pivotable legs in multiple alternate positions;

FIG. 7 is a bottom perspective view of a top of a device in accordance with an embodiment of the invention showing pivotable legs in multiple alternate positions;

FIG. 8 is a top view of a device in accordance with an embodiment of the invention showing the device in a collapsed or folded position; and

FIG. 9 is a bottom view of a top of a device in accordance with an embodiment of the invention showing the device in a collapsed or folded position.

### DESCRIPTION OF EMBODIMENTS

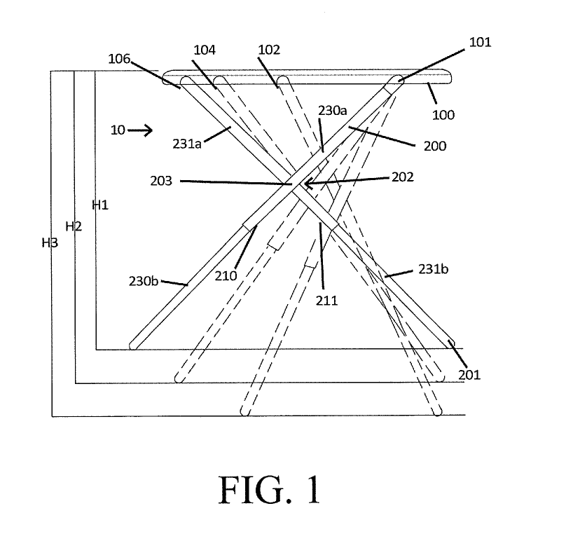

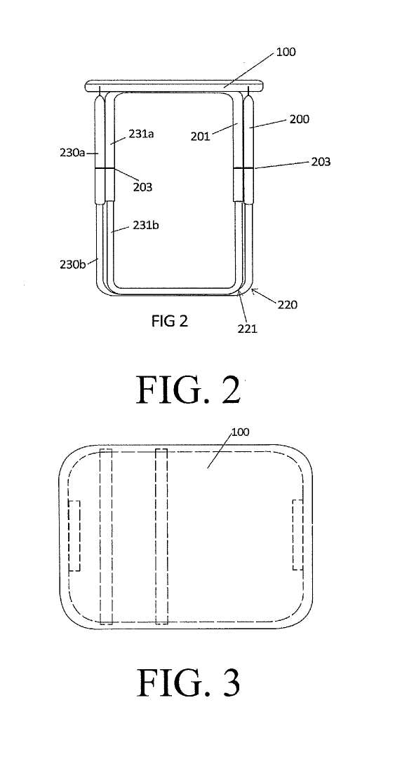

In accordance with an embodiment of the invention as shown in FIGS. 1-4, a device 10, referred to herein as a device, is constructed and arranged to support the legs and/or feet of a user to relieve back pain. Because people have different lengths of buttocks-popliteus lengths and because in accordance with an embodiment of the invention it is desirable to have users elevate their legs such that their knees are bent at a 90° angle with their thighs perpendicular to their backs (as shown in FIG. 5), a device in accordance with one exemplary embodiment of the invention is adjustable to be suitable for such users.

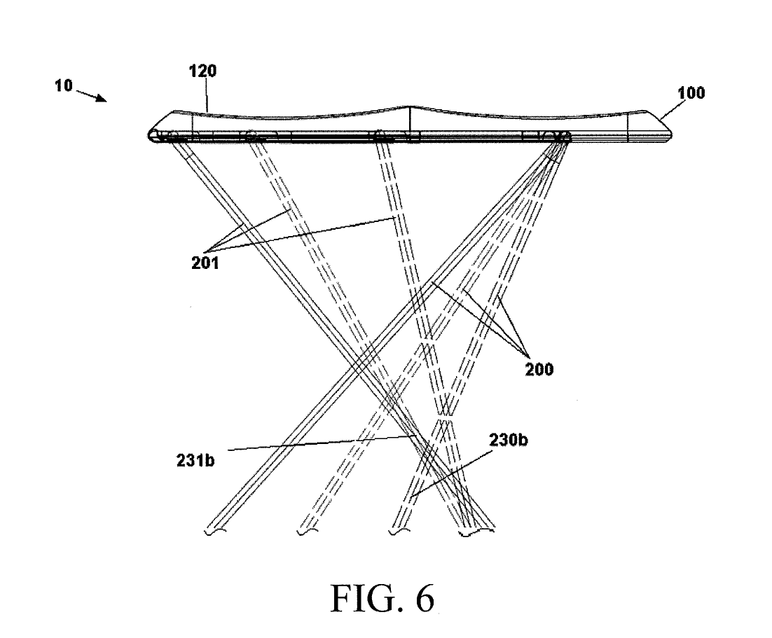

In general, the device 10 of the present embodiment comprises a top 100, including a top surface and a bottom surface (120 and 130, respectively, in FIGS. 6-9), substantially parallel to the surface on which it is placed, the top 100 supported by two legs 200, 201. In accordance with one embodiment of the invention, the user can lie on a flat surface, such as a bed, a floor, etc., and adjust the height of device 10 by altering the position of the legs 200, 201 with respect to the top 100. The user can place his/her lower legs or feet on top 100 while laying on the surface upon which device 10 is placed.

In accordance with an embodiment of the invention, device 10 is manufactured using a relatively light-weight material. By way of non-limiting example, device 10 or portions thereof can be constructed of aluminum or any other suitable material. A light-weight material is preferable because it is common for persons suffering from back pain not to be able to lift heavy objects. Therefore, device 10 can be moved from place to place according to when and where the user wishes to use it.

Preferably, device 10 is foldable, which can facilitate transportation and storage. Top 100 preferably includes a relatively soft, cushioned material or layer 108 to provide comfort to the user.

The present illustrative embodiment of the invention comprises two legs 200, 201 although other number and arrangement of legs could be used. Legs 200, 201 comprise metal and be tubular having a hollow center. Legs 200, 201 can intercross and form an “x”. Legs 200, 201 are preferably held together at an intersection 202 by a bolt 203 about which leg 201 can pivot with respect to leg 200. In accordance with the embodiment shown in FIGS. 1-4, leg 200 pivots about a bolt 101 in top 100. Therefore, the angle of leg 200 with respect to top 100 and leg 201 controls the height of device 10.

In accordance with the present exemplary embodiment of the invention, leg 201 has a length of about 56 cm, capable of adjusting the height of device 10 to a height of between about 60 cm and 30 cm, more preferably between about 53 cm and 43 cm. In accordance with this embodiment of the invention, a plurality of heights of device 10 is provided, preferably at 43 cm, 48 cm and 53 cm.

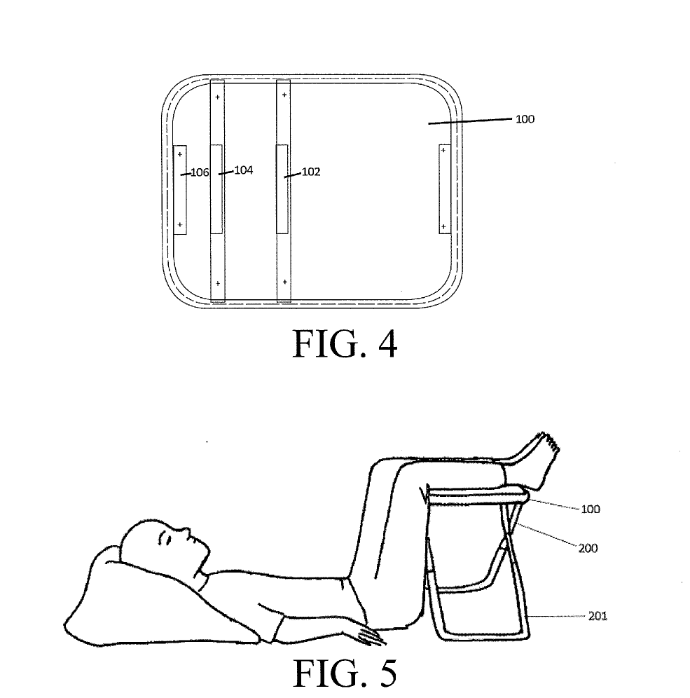

Top 100 preferably includes one or more stopping mechanisms for receiving the top of leg 201 (which in the present embodiment is parallel to the plane of the top 100), such as stoppers, brackets, detents, grooves, pins, strap(s) and other structures for receiving or stopping a portion of leg 201. As shown in FIGS. 1 and 4, top 100 includes a plurality of brackets 102, 104, 106. Brackets 102, 104, 106 are constructed and arranged to receive a top portion of leg 201, thus preventing the top of leg 201 from pivoting away from leg 200 any further and maintaining the height of device 10. As illustrated in FIG. 1, device 10 can provide a variety of heights H1, H2, H3, according to which bracket 106, 104, 102 is engaged by leg 201. Accordingly, the combination of the legs 200, 201 and the brackets 102, 104, 106 makes up a height adjusting assembly. Whereas three brackets and three heights are shown in FIG. 1, it is to be understood that the number of possible heights (as well as the actual heights provided) of device 10 can be altered without deviating from the scope of the invention. The device can include telescoping legs for adjusting the height, either in combination with or in lieu of the pivoting arrangement shown in FIG. 1.

In accordance with an exemplary embodiment of the invention, a bracket 106 is located proximate one edge of top 100, wherein top 100 has a length of about 400 mm. Bracket 106 is located about 18 mm from the edge opposite hinge 101 to provide a first height H1 of device 10, and each of the other brackets 104, 102 is located progressively further away from the edge to provide a second H2 and third height H3 of device 10, greater than the first height. Additionally, brackets 104 and 102 can be about 69 mm and 157 mm from the edge of the top, respectively. When leg 201 engages bracket 106, the device has a height H1 of approximately 43 cm, when leg 201 engages bracket 104, the device 10 has a height H2 of approximately 48 cm, and when leg 201 engages bracket 102, the device 10 has a height H3 of approximately 53 cm.

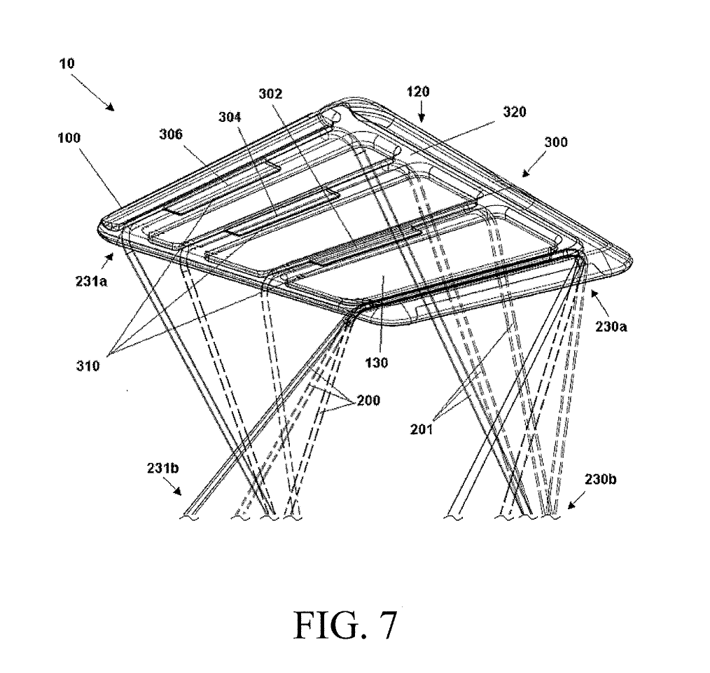

In certain embodiments, such as those of FIGS. 6-9, grooves 306, 304, 302 may be used in place of brackets 106, 104, 102. As shown in FIG. 7, groove 306 is located proximate one edge of top 100, wherein top 100 has a length of about 400 mm. Groove 306 is located about 18 mm from the edge opposite hinge 101 to provide height H1 of device 10. The other grooves 304, 302 are located progressively further away from the edge to provide height H2 and height H3 of device 10, both greater than height H1. Groove 304 may be 69 mm from the edge of the top 100 and groove 302 may be 157 mm from the edge of the top 100. When leg 201 engages groove 304, the device 10 has a height H2 of approximately 48 cm. When leg 201 engages groove 302, the device 10 has a height H3 of approximately 53 cm.

Mass produced chairs available in the market are usually about 43 cm high. The median American male's popliteal height (the distance from the underside of the foot to the underside of the thigh at the knees when sitting) is 41.5 cm, and that of the median American female is 38 cm.

Because device 100 is preferably used by a user lying down with his/her thighs perpendicular to his/her back, the height of device 10 should accommodate at least approximately the buttock popliteal length of the user, i.e., the vertical distance from the rearmost part of the buttocks to the back of the knee. Statistically, less than 5% of males and females have a buttock popliteal length of 43 cm; 50% have less than 48 cm and 95% have less than 53 cm. Accordingly, it is preferable for device 10 to have at least one adjustable height of between approximately 35 cm and 55 cm. By way of non-limiting example, device 10 can be adjustable to three different heights: 43 cm, 48 cm and 53 cm corresponding to the three different brackets. However, it is to be understood that other heights can be used, and more or less variations in height can be provided by device 10 without deviating from the scope of the invention. Thus, devices according to the present invention may be sold in various sizes, for example, small, medium and large, with the different sizes having a generally progressive range of heights (e.g., small: 30-45 cm; medium: 40-55 cm; large: 50-60 cm).

The upper portion 230a of leg 200 is pivotably fixed to the top 100. Leg 200 is pivotable with respect to top 100 and leg 201 until leg 200 is parallel with top 100 and leg 201, thus permitting device 10 to be folded to facilitate storage and/or transport as further described below. In accordance with one embodiment of the invention, legs 200, 201 include a curved portion 220, 221 which can facilitate stabilizing device 10 on a surface, more particularly a soft surface such as a bed. For example, the soft surface can hug the curvature of curved portion 220, 221.

Furthermore, in the present embodiment, each leg 200, 201 is generally comprised of two or more pieces whose ends are matable and telescoping, secured together by spring locks 210, 211 or other locking mechanism. Thus, leg 200 can be disassembled, removed, collapsed, retracted, etc. to facilitate storage or transportation. In the embodiment shown in FIG. 1, leg 200 includes two upper portions 230a which is pivotally attached to top 100, and a lower U-shaped portion 230b, which is maintained in position with respect to upper portion 230a via spring locks 210. Likewise, leg 201 includes a U-shaped upper portion 231a which is received by bracket 102, 104, 106 to adjust the height of device 10, and a U-shaped lower portion 231b maintained in position with respect to upper portion 231a via spring locks 211. In accordance with one embodiment of the invention, the lower portions 230b, 231b can be adjusted with respect to the upper portions 230a, 230b, for example, telescopically, to adjust the length of legs 200, 201. By providing legs of adjustable height, the range of heights of device 10 can be substantially increased. For example, if the legs have three different height settings, and the top has three brackets, grooves, or other stopping mechanisms, the device could provide nine different heights for the user to choose from. Such an arrangement can provide the user with narrower increments in height of device 10, thus providing a more tailored device for meeting the needs of the user.

Lower portions 230b, 231b is preferably removable from upper portions 230a, 231a, to facilitate storage or transportation of device 10 when not in use. Alternatively, lower portions 230b, 231b can be inserted into or receive upper portions 230a, 231a such that when collapsed, the legs 200, 201 do not extent beyond the length of top 100.

Additionally, a locking mechanism can be included for securing legs 200, 201 in the desired position, for example, at the selected height. By way of non-limiting example, a spring lock, clamp, strap, detent and other known locking mechanisms can be used.

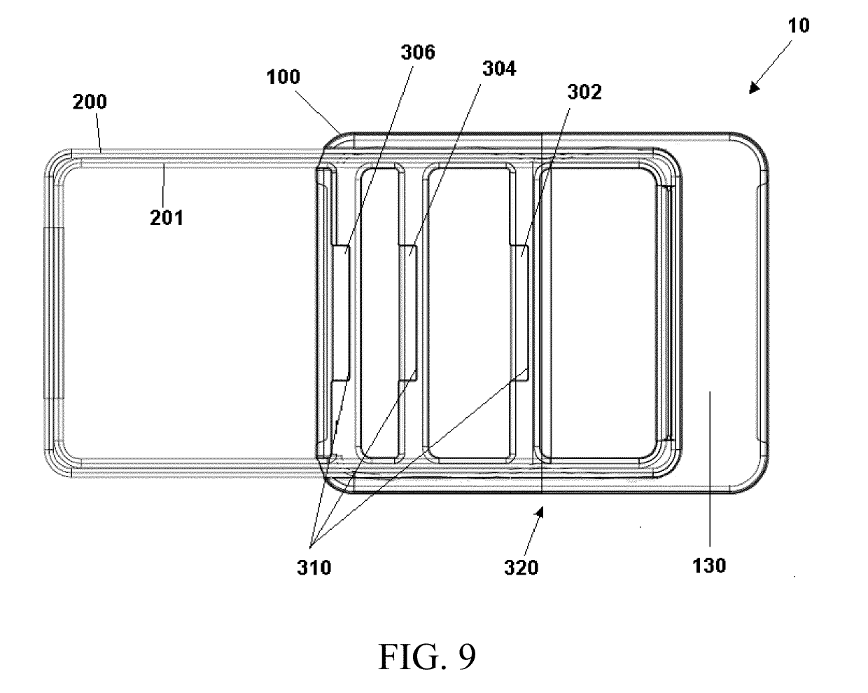

In this regard, FIGS. 7 and 9 illustrate grooves 306, 304, 302 that include one such locking element—such as protrusions 310—each of which extends from the bottom surface 130 adjacent a different groove 306, 304, 302, and contacts the upper portion 231a of leg 201, securing leg 201 when it is placed into either of the grooves 306, 304, 302 (e.g., creating a snap-fit between the leg 201 on one hand, and the combination of a groove 306, 304, 302, and a protrusion 310, on the other hand).

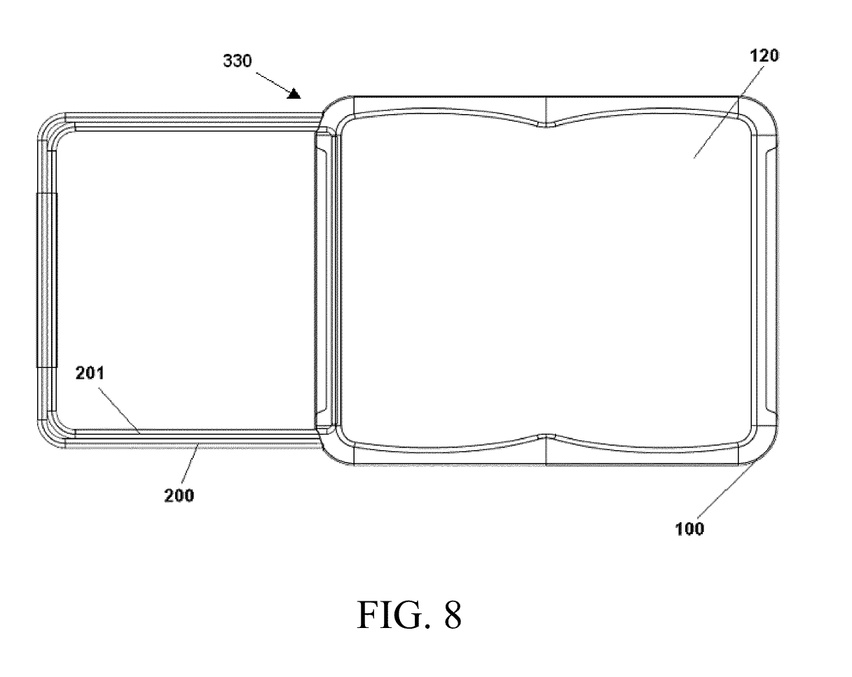

In certain embodiments, as shown in FIGS. 6 and 8, top 100 may also include one or more contours 300 on the top surface 120. The contours 300 are shaped to accommodate one or both legs or feet of the user while the user's legs or feet are supported by the top 100. The contours 300 provide added comfort to the user while using device 10.

In certain embodiments, device 10 is collapsible into a folded position via recesses 320 provided on the bottom surface 130 of the top 100. As shown in FIGS. 7-9, in such embodiments, the recesses 320 are constructed and arranged to receive the legs 200, 201 when they are folded flat against the bottom surface 130 of the top 100.

In the embodiment of FIGS. 6-9, the recesses 320 correspond to the location of the legs 200, 201 when the legs 200, 201 are displaced such that they are substantially aligned with and/or within the plane of the top 100 (as shown in FIGS. 7 and 9). The recesses 320 are constructed and sized to receive portions of the legs 200, 201. More specifically, as noted above, the upper portion 230a of leg 200 may be pivotably fixed to the top 200 such that at least a portion of leg 200, proximate the upper portion 230a, is recessed into the top 100. A portion of recesses 320 may extend generally parallel to the upper portion 230a of leg 200 that is recessed into the top 100 to receive the upper portion 231a of leg 201 when the device 10 is folded. In other words, the recess 320 is generally U-shaped for receiving the upper portion(s) 230a, 231a of the legs 200, 201. This portion of leg 201 received by recess 320, in the present embodiment, includes the same portion received by the grooves 306, 304, 302 when the device 10 is configured for use. Recesses 320 also extend along opposite sides of the top 100 and through an end 330 of the top 100, as shown in FIG. 8.

In operation, the leg 201 is displaced toward leg 200 and the upper portion 231a of leg 201 is received into the portion of the recess 320 proximate the upper portion 230a of the leg 200. Leg 200, which is pivotably mounted to top 100, and leg 201 is then pivoted toward the top 100 so that at least a portion of the legs 200, 201 are received into the recess 320 and placed into alignment with the plane of the top 100. Notably, leg 201 is sized to fit within leg 200 (i.e., leg 201 is narrower than leg 200 and extends a shorter distance than leg 200) when the device is in the folded or collapsed position. The device 10 is thus rendered substantially flat for portability and ease of storage.

It is to be understood that the examples provided are merely exemplary, as a matter of application specific to design choice, and should not be construed to limit the scope of the invention in any way.

Thus, while there have been shown and described and pointed out novel features of embodiments of the present invention, materials, dimensions, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

1-17. (canceled)

18. An apparatus to be placed on a surface on which a user is to lie, the apparatus for supporting the legs or feet of the user, the apparatus comprising:
a top defining a plane, the top having a bottom surface, the bottom surface including a first stopper;
a leg assembly having a first leg pivotable with respect to the top, the first leg having a first position in which the first leg contacts the first stopper, the leg assembly constructed to support the top at a first height above the surface when the first leg is in the first position; and
at least one recess disposed on the bottom surface of the top, the recess constructed and arranged to receive at least a portion of the first leg, wherein the first leg has a third position in which at least a portion of the first leg is received into the recess and is positioned substantially in alignment with the plane of the top.

19. The apparatus of claim 18 wherein the leg assembly further includes a second leg, the first leg and the second leg pivotably affixed to each other and wherein the recess is configured to receive the first leg and second leg when the first leg is in the third position.

20. The apparatus of claim 19 wherein the top further includes an end and the recess extends through the end, the first leg and second leg extending through the recess and the end when the first leg is in the third position.

21. The apparatus of claim 20 wherein the first leg and second leg are each substantially rectangular in shape, the first leg having a first width and the second leg having a second width larger than the first width such that the first leg fits within the second leg when the first leg is in the third position.

22. The apparatus of claim 18 wherein:
the bottom surface of the top further includes a second stopper spaced a distance apart from the first stopper; and
the first leg has a second position in which the first leg contacts the second stopper, the leg assembly constructed to support the top at a second height above the surface when the first leg is in the second position, the second height being different from the first height.

23. The apparatus of claim 18, wherein the first leg has a length and includes a first upper portion and a first lower portion, the first upper portion selectively positionable with respect to the first lower portion to adjust the length of the first leg.

24. The apparatus of claim 18, wherein the leg assembly includes a second leg having a length and includes a second upper portion and a second lower portion, the second upper portion selectively positionable with respect to the second lower portion to adjust the length of the second leg, wherein the second leg is movably attached to the top such that the top can be selectively positioned with respect to the leg assembly.

25. The apparatus of claim 23 wherein when the first leg is in the first position, the first upper portion is selectively positionable relative to the first lower portion between a first length, when the top is supported at the first height, and a second length, when the top is supported at a height different than the first height.

26. The apparatus according to claim 24, wherein the first leg is pivotably attached to the second leg.

27. The apparatus of claim 18, wherein the first height is between 35 cm and 55 cm.

28. The apparatus of claim 18, wherein the bottom surface of the top further includes a second stopper and third stopper and the apparatus is adjustable between at least three heights corresponding to the first stopper, second stopper, and third stopper.

29. The apparatus of claim 18, wherein the apparatus includes a spring lock constructed and arranged to secure the leg assembly.

30. The method of claim 18 wherein the top further includes a top surface having at least one contour to receive at least one leg or foot of the user.

31. The apparatus of claim 18 wherein the first stopper includes a first protrusion constructed and arranged to retain the position of the first leg when the first leg is in the first position.

32. The apparatus of claim 19 wherein the second stopper includes a second protrusion constructed and arranged to retain the position of the first leg when the first leg is in the second position.

33. A method of supporting legs or feet of a user, the method comprising:
providing an apparatus to support the user's legs, the apparatus including a top and a leg assembly, wherein:
the top defines a plane having a bottom surface, the bottom surface including a first stopper and at least one recess;
the leg assembly has a first leg with a first upper portion, the first leg being pivotable with respect to the top allowing the first upper portion to engage the first stopper to support the top at a first height; and
the first leg being pivotable into a folded position in which at least a portion of the first leg is received into the recess and is positioned substantially in alignment with the plane of the top;
engaging the first upper portion with the first stopper thereby supporting the top at a first height;
laying the user on a surface such that the user's back is substantially flat on the surface;
supporting the user's lower leg or foot on the top while the first upper portion is engaged with the first stopper;
removing the user's lower leg or foot from the top;
disengaging the first upper portion of the first leg from the first stopper; and
collapsing the apparatus by engaging at least a portion of the first leg with the recess.

34. The method of claim 33 wherein the bottom surface of the top includes a second stopper, wherein the first leg is pivotable to engage the second stopper to support the top at a second height, wherein the method further includes selecting between the first height and the second height based on the user's buttocks-popliteus length, the engaging of the first upper portion with the first stopper being based on selection of the first height.

35. The method of claim 33 wherein the leg assembly includes a second leg movably attached to the top.

36. The method of claim 33 wherein the leg assembly includes a height adjusting element to adjust the height of the top from the surface.

37. The method of claim 33 wherein the top further includes a top surface having at least one contour to receive at least one leg or foot of the user.

38. The apparatus of claim 33 wherein:
the first stopper includes a first protrusion constructed and arranged to retain the position of the first leg when the top is supported at the first height; and

39. The apparatus of claim 34 wherein:
the second stopper includes a second protrusion constructed and arranged to retain the position of the first leg when the top is supported at the second height.

40. A method of a user using an apparatus having a top including a bottom surface having a first stopper and at least one recess and a first leg, the first leg pivotable to contact the first stopper to support the top at a first height, the recess capable of receiving at least a portion of the first leg, the method comprising:
instructing the user to lie down on a surface such that the user's back is substantially flat on the surface; and
instructing the user to place the user's leg or foot on the apparatus such that the user's knee is at substantially a 90 degree angle and the user's thigh is substantially perpendicular to the surface.

41. The method of claim 40 wherein the bottom surface further includes a second stopper and the first leg is pivotable to contact the second stopper to support the top at a second height, wherein the method further includes instructing the user to adjust the height of the apparatus to about buttocks-popliteus length of the user by positioning the first leg at the first stopper or the second stopper.

42. The method of claim 40 wherein the apparatus further includes a second leg movably attached to the top.
